(19) United States
(12) Patent Application Publication
(10) Pub. No.: US 2026/0156354 A1
(43) Pub. Date: Jun. 4, 2026

(54) IMAGE CAPTURING APPARATUS AND MEDIUM

(71) Applicant: CANON KABUSHIKI KAISHA, Tokyo (JP)

(72) Inventor: NAOMI MORI, Kanagawa (JP)

(21) Appl. No.: 19/177,376

(22) Filed: Apr. 11, 2025

(30) Foreign Application Priority Data
Apr. 16, 2024 (JP) 2024-066051

(51) Int. Cl. H04N 23/667; H04N 23/67

(52) U.S. Cl. CPC H04N 23/667; H04N 23/675

(57) ABSTRACT

According to an aspect of the present disclosure, there is provided an image capturing apparatus that comprises at least one processor and at least one memory that is in communication with the at least one processor. The at least one memory stores instructions for causing the at least one processor and the at least one memory to allow a focus mode to be set as autofocus to automatically focus on a subject or as manual focus to manually focus on a subject, and control a multi-use operation member capable of switching to be operated as a first operation member for manual focus operation or operated as a second operation member for operation other than the manual focus operation, to be operated as the first operation member when the focus mode is manual focus.

### BACKGROUND

### Field of the Disclosure

The present disclosure relates to an image capturing apparatus and a medium.

### Description of the Related Art

Like a lens interchangeable type camera or the like, in a case of a structure in which a barrel protrudes from a main body of the camera towards a subject, a photographer holds and supports the barrel with a left hand. In a case where the camera is held in such a manner, since the left hand is regularly in contact with the barrel, a ring may be mounted to the barrel with which a predetermined operation can be performed. This type of the ring includes, for example, a focus ring which enables a manual focus operation by a user.

Here, it is difficult to mount a plurality of rings to the barrel in a small lens or an inexpensive lens. In view of the above, a multi-use ring which can be switched to be operated as a focus ring or as a ring for operation other than the manual focus operation may be mounted.

However, in a case where the multi-use ring is mounted, there is a combination in which the multi-use ring is set to be operated as the ring for operation other than the manual focus operation and the focus mode is set as manual focus. In this combination, it is difficult to realize a focused state quickly from a blurred state by using the multi-use ring. To realize the focused state, switching is to be performed to set the multi-use ring to be operated as the focus ring, or the focus mode is to be switched to autofocus. However, in the small lens or the inexpensive lens, it is difficult to mount, to the barrel, a switch for switching of the multi-use ring and switching of the focus mode. For this reason, these switching operations are to be performed from a setting menu on the camera main body side, for example, and a posture to hold the camera is to be broken to impair operability. Such a combination of the setting of the multi-use ring and the focus mode may cause a complication.

Japanese Patent Laid-Open No. 2009-3121 describes a camera in which autofocus and manual focus can be switched, and, in a manual focus state, a focal position of a lens can be moved by turning an MF adjustment dial.

### SUMMARY

According to an aspect of the present disclosure, some embodiments are able to remove complications caused by a combination of a setting of a multi-use operation member and a focus mode.

According to an aspect of the present disclosure, there is provided an image capturing apparatus including at least one processor and at least one memory that is in communication with the at least one processor. The at least one memory stores instructions for causing the at least one processor and the at least one memory to allow a focus mode to be set as autofocus to automatically focus on a subject or as manual focus to manually focus on a subject, and control a multi-use operation member capable of switching to be operated as a first operation member for manual focus operation or operated as a second operation member for operation other than the manual focus operation, to be operated as the first operation member when the focus mode is manual focus.

Further features of various embodiments will become apparent from the following description of exemplary embodiments with reference to the attached drawings.

### BRIEF DESCRIPTION OF THE DRAWINGS

FIGS. 1A and 1B are external appearance views of a digital camera according to a first embodiment.

FIG. 2 is a block diagram illustrating a configuration example of the digital camera.

FIG. 3 is a flowchart illustrating processing executed by the digital camera.

FIG. 4 is a flowchart illustrating a detail of F/C multi-use ring operation tentative decision processing.

FIG. 5 is a flowchart illustrating a detail of focus mode tentative decision processing.

FIGS. 6A to 6E illustrate display examples of a setting screen.

FIGS. 7A to 7G illustrate configuration examples of a lens unit.

FIG. 8 is an external appearance view of the digital camera (with the presence of an AF/MF switch).

FIG. 9 is a flowchart illustrating a detail of F/C multi-use ring and focus mode decision processing.

FIG. 10 is a flowchart illustrating a detail of the F/C multi-use ring and focus mode decision processing according to a second embodiment.

### DESCRIPTION OF THE EMBODIMENTS

Hereinafter, embodiments of the present disclosure will be described with reference to the accompanying drawings.

### First Embodiment

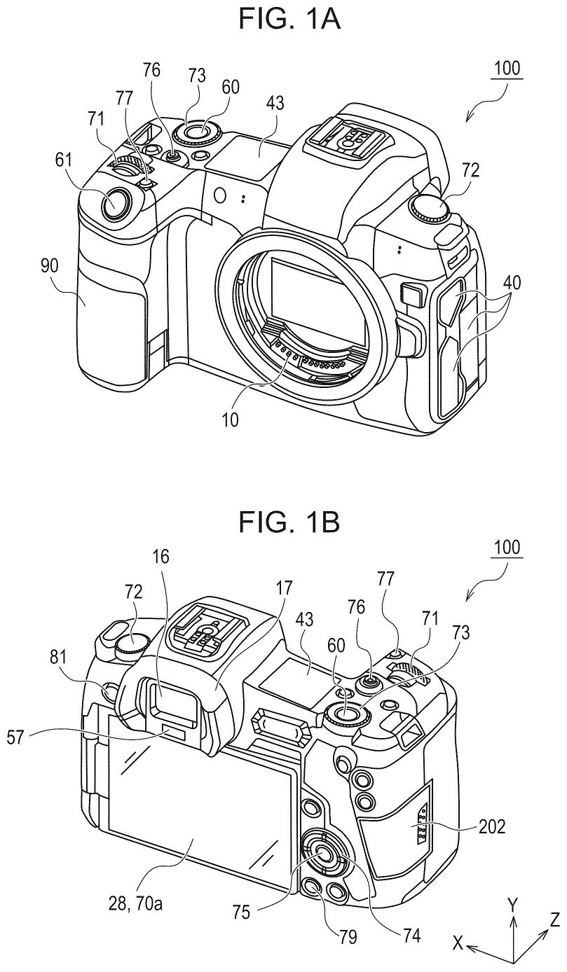

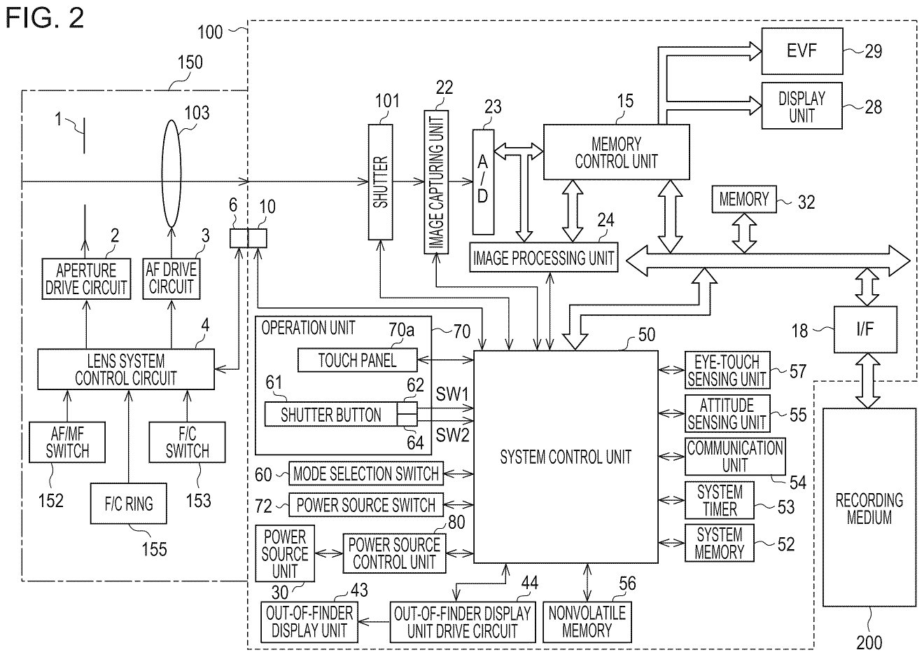

FIGS. 1A and 1B are external appearance views of a digital camera (hereinafter, simply referred to as a camera) 100 serving as an example of an image capturing apparatus to which embodiments of the present disclosure are applied. FIG. 1A is a front face perspective view of the camera 100, and FIG. 1B is a rear face perspective view of the camera 100. A lens unit 150 (see FIG. 2) which will be described below can be detachably attached to the camera 100.

The camera 100 is an image capturing apparatus configured to allow a focus mode to be set as autofocus to automatically focus on a subject or as manual focus to manually focus on a subject.

A display unit 28 is a display unit provided on a rear face of the camera 100 and displays an image or various information. A touch panel 70a detects a touch operation on a display surface (touch operation surface) of the display unit 28. An out-of-finder display unit 43 is a display unit provided on a top face of the camera 100 and displays various setting values, such as a shutter speed and an aperture. A shutter button 61 is an operation member configured to issue a shooting instruction. A mode selection switch 60 is an operation member arranged to switch various modes. A terminal cover 40 is a cover which protects a connector (not illustrated) with a connection cable or the like which connects the camera 100 to an external device.

A main electronic dial 71 is a rotary operation member and is used to perform changes or the like of the setting values, such as the shutter speed and the aperture. A power source switch 72 is an operation member arranged to switch ON and OFF of a power source to the camera 100. A sub electronic dial 73 is a rotary operation member and is used for movement of a selection frame (cursor), image feed, or the like. A four-way operative key 74 is configured such that each of upper, lower, left, and right parts can be pressed, and processing according to a pressed part is executed. A SET button 75 is an operation member to be used to mainly decide a selected item or the like. A movie button 76 is an operation member arranged to instruct start or stop of movie shooting (recording). An M-Fn button 77 is an operation member arranged to swiftly change various settings, such as a white balance and an ISO sensitivity, by being pressed in a shooting standby state. In addition, during calibration, the M-Fn button 77 can be used for a viewpoint confirmation operation. A playback button 79 is an operation member arranged to switch a mode between a shooting mode and a playback mode. By pressing the playback button 79 during the shooting mode, the mode shifts to the playback mode, and a latest image among images recorded in a recording medium 200, which will be described below, can be displayed on the display unit 28. A menu button 81 is an operation member arranged to perform an instruction operation of displaying a menu screen. By pressing the menu button 81, the menu screen with which various settings can be carried out is displayed on the display unit 28. A user can intuitively carry out various settings by using the menu screen displayed on the display unit 28, the four-way operative key 74, and the SET button 75.

A communication terminal 10 is a communication terminal for the camera 100 to communicate with the lens unit 150. An eyepiece unit 16 is an eyepiece unit of an eyepiece finder (look-through type finder), and the user can visually recognize video displayed on an internal electronic view finder (EVF) 29 via the eyepiece unit 16. An eye-touch sensing unit 57 is constituted by an eye-touch detection sensor configured to sense whether the user (photographer) puts an eye on the eyepiece unit 16. A lid 202 is a lid for a slot in which the recording medium 200 is stored. A grip portion 90 is a holding portion with a shape designed to be easy to grip with a right hand when the user holds the camera 100. In a state in which the camera 100 is held by gripping the grip portion 90 with a little finger, a ring finger, and a middle finger of the right hand, the shutter button 61 and the main electronic dial 71 are arranged in such positions that they can be operated by an index finger of the right hand. In addition, in a state in which the grip portion 90 is held by the right hand, the sub electronic dial 73 is arranged in such a position that it can be operated by a thumb of the right hand.

FIG. 2 is a block diagram illustrating a configuration example of the camera 100 and the lens unit 150. It is noted that the same components as the components illustrated in FIG. 1 are denoted by the same reference signs.

The lens unit 150 is detachably mounted to the camera 100. The lens unit 150 includes an aperture 1, a lens 103, an aperture drive circuit 2, an AF drive circuit 3, a lens system control circuit 4, and a communication terminal 6. Normally, the lens 103 is constituted by a plurality of lenses but is illustrated by only a single lens herein for simplicity. The communication terminal 6 is a communication terminal for the lens unit 150 to communicate with the camera 100. The lens unit 150 communicates with a system control unit 50 via the communication terminals 6 and 10. In the lens unit 150, the aperture 1 is controlled by the lens system control circuit 4 via the aperture drive circuit 2. In addition, in the lens unit 150, focus is adjusted by shifting a position of the lens 103 by the lens system control circuit 4 via the AF drive circuit 3.

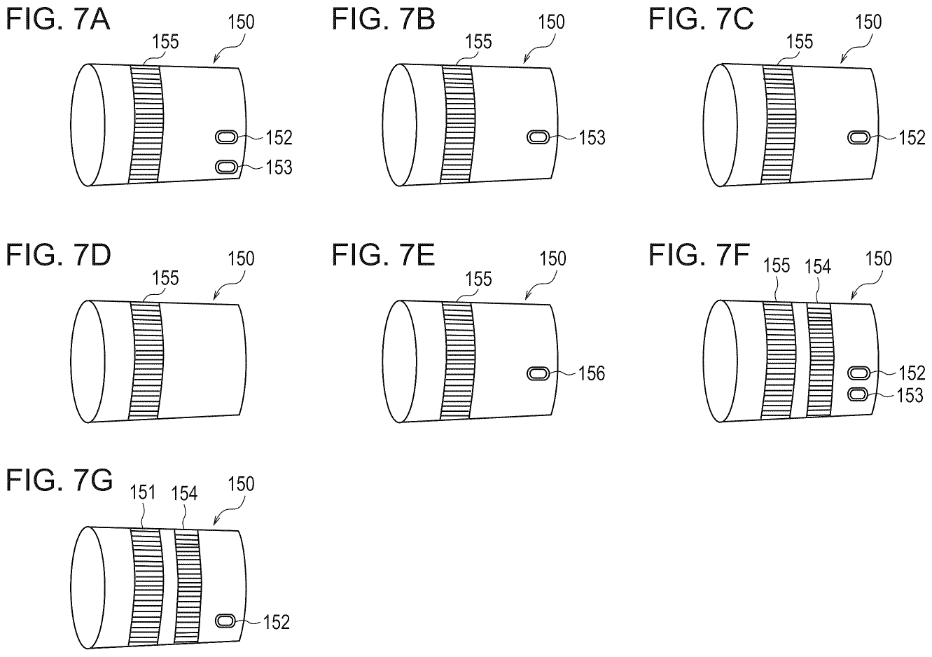

As illustrated in FIG. 7A, an AF/MF switch 152, a focus/control multi-use ring (F/C multi-use ring) 155, and a focus/control selection switch (F/C switch) 153 are mounted to a lens barrel of the lens unit 150.

The AF/MF switch 152 is a focus mode setting unit and is a switch to switch a focus mode to autofocus (AF) or manual focus (MF). The user can select AF or MF by switching a position of the AF/MF switch 152. When the focus mode is AF, focus is adjusted by shifting the lens 103 via the AF drive circuit 3. When the focus mode is MF, the lens 103 is shifted through an MF operation by the user.

The F/C multi-use ring 155 is a multi-use operation member capable of being switched to be operated as a focus ring or operated as a control ring. The F/C multi-use ring 155 can be rotated around an optical axis of the lens barrel.

Herein, the focus ring refers to a ring which enables the MF operation. According to the present embodiment, the focus ring is equivalent to an example of a first operation member for manual focus operation. In addition, the control ring refers to a ring which can allocate a desired function (such as a shutter speed setting, an aperture setting, or an ISO sensitivity setting) and enables a camera setting operation by the user. According to the present embodiment, the control ring is equivalent to an example of a second operation member for operation other than the manual focus operation.

The F/C switch 153 is a switch configured to select whether the F/C multi-use ring 155 is operated as the focus ring or operated as the control ring. The F/C switch 153 is a switch having two positions of focus (F) and control (C). When the user switches the F/C switch 153, such a setting can be configured that the F/C multi-use ring 155 is switched to be operated as the focus ring or operated as the control ring. According to the present embodiment, the F/C switch 153 is equivalent to a predetermined operation unit.

It is noted that there are a variety of combinations of switches and rings present in the lens barrel, and examples thereof will be described below with reference to FIGS. 7A to 7G.

A shutter 101 is a focal plane shutter capable of freely controlling an exposure time period of an image capturing unit 22 under control of the system control unit 50.

The image capturing unit 22 includes an image sensor constituted by a charge coupled device (CCD), a complementary metal oxide semiconductor (CMOS) element, or the like configured to convert an optical image into an electric signal.

An analog-to-digital (A/D) converter 23 converts an analog signal output from the image capturing unit 22 to a digital signal.

An image processing unit 24 performs predetermined processing (such as pixel interpolation, resize processing such as size reduction, or color conversion processing) on data from the A/D converter 23 or data from a memory control unit 15. In addition, the image processing unit 24 performs predetermined arithmetic processing by using the captured image data, and the system control unit 50 performs exposure control and ranging control based on a calculation result obtained by the image processing unit 24. As a result, AF processing of through-the-lens (TTL) metering, automatic exposure (AE) processing, pre-flash (EF) processing, and the like are performed. The image processing unit 24 also performs predetermined arithmetic processing by using the captured image data to perform auto white balance (AWB) processing of the TTL metering based on the obtained calculation result.

The memory control unit 15 controls data transmission and reception between the A/D converter 23, the image processing unit 24, and a memory 32. Output data from the A/D converter 23 is written, via the image processing unit 24 and the memory control unit 15, or via the memory control unit 15 without intermediation of the image processing unit 24, to the memory 32. The memory 32 stores image data obtained by the image capturing unit 22 and converted to the digital data by the A/D converter 23 and image data to be displayed on the display unit 28 or the EVF 29. The memory 32 includes a memory capacity sufficient enough to store a predetermined number of still images and a predetermined time period of moving picture and audio. In addition, the memory 32 also serves as a memory (video memory) for image display. The image data for display, which is written to the memory 32, is displayed by the display unit 28 or the EVF 29 via the memory control unit 15. The display unit 28 or the EVF 29 performs display according to signals from the memory control unit 15 on a display, such as a liquid crystal display (LCD) or an organic electro luminescence (EL). The digital signals that have been A/D converted by the A/D converter 23 and accumulated in the memory 32 are sequentially transferred to the display unit 28 or the EVF 29 for display, so that live-view display is performed. An image subjected to the live-view display is referred to as a live-view image.

The various setting values such as the shutter speed and the aperture are displayed on the out-of-finder display unit 43 via an out-of-finder display unit drive circuit 44.

A nonvolatile memory 56 is an electrically erasable and recordable memory, and a flash read only memory (ROM) or the like is used, for example. The nonvolatile memory 56 stores a constant for operation of the system control unit 50, a program, or the like.

The system control unit 50 is a control unit constituted by at least one processor or circuit and controls the entire camera 100. The system control unit 50 realizes each processing which will be described below by executing the program stored in the nonvolatile memory 56. The system control unit 50 also performs display control by controlling the memory 32, the display unit 28, or the like.

A system memory 52 is, for example, a random access memory (RAM). The system control unit 50 expands the constant for operation of the system control unit 50, a variable, the program read from the nonvolatile memory 56, or the like into the system memory 52.

A system timer 53 is a time measurement unit configured to measure time used for various types of control and to measure time of a built-in clock.

A power source control unit 80 is constituted by a battery detection circuit, a DC-DC converter, a switch circuit to switch a block to be energized, or the like and detects the presence or absence of a battery, a type of the battery, a battery level, or the like. In addition, the power source control unit 80 controls the DC-DC converter, based on the detection result and instructions of the system control unit 50, to supply demanded power to each unit including the recording medium 200 for a demanded period. A power source unit 30 is constituted by a primary battery, such as an alkaline battery or a lithium battery; a secondary battery, such as a NiCd battery, a NiMH battery, or an Li battery; an AC adapter; and the like.

An interface (I/F) 18 is an interface with the recording medium 200 (e.g., a memory card, a hard disk). The recording medium 200 is a recording medium, such as a memory card, configured to record the shot image and is constituted by a semiconductor memory, a magnetic disc, or the like.

A communication unit 54 transmits and receives video signals and audio signals with an external device wirelessly connected or connected by a wired cable. The communication unit 54 can also be connected to a wireless local area network (LAN) or the Internet. In addition, the communication unit 54 can communicate with the external device through Bluetooth® or Bluetooth Low Energy. The communication unit 54 can transmit the image captured by the image capturing unit 22 (including the live-view image) and the image recorded in the recording medium 200 and can receive image data and various other information from the external device.

An attitude sensing unit 55 senses an attitude of the camera 100 relative to the direction of gravity. The image captured by the image capturing unit 22 can be determined, based on the attitude sensed by the attitude sensing unit 55, as an image shot when the camera 100 is held laterally or an image shot when the camera 100 is held longitudinally. The system control unit 50 can add orientation information according to the attitude sensed by the attitude sensing unit 55 to an image file of the image captured by the image capturing unit 22 or rotate the image to be recorded. An acceleration sensor, a gyro sensor, or the like can be used as the attitude sensing unit 55. By using the acceleration sensor or the gyro sensor serving as the attitude sensing unit 55, a motion of the camera 100 (pan, tilt, or lift, whether or not the camera 100 is stationary, or the like) can also be sensed.

The eye-touch sensing unit 57 is an eye-touch detection (approach detection) sensor configured to sense the approach (touch) and retreat (withdrawal) of the eye (object) with respect to the eyepiece unit 16 in an eyepiece finder 17. The system control unit 50 switches display (display state)/non-display (non-display state) of the display unit 28 and the EVF 29 according to a state sensed by the eye-touch sensing unit 57. Specifically, in a case where at least the state is the shooting standby state and a switching setting of a display destination is automatic switching, during a non-eye-touch period, the display destination is set as the display unit 28 to turn on its display and turn off the display of the EVF 29. On the other hand, during an eye-touch period, the display destination is set as the EVF 29 to turn on its display and turn off the display of the display unit 28. An infrared proximity sensor can be used as the eye-touch sensing unit 57, for example, and an approach of any object to the eyepiece unit 16 in the eyepiece finder 17 with the built-in EVF 29 can be sensed. In a case where the object approaches, infrared rays projected from a light projection unit (not illustrated) of the eye-touch sensing unit 57 reflect on the object to be received by a light reception unit (not illustrated) of the infrared proximity sensor. A distance of the approaching object to the eyepiece unit 16 (eye-touch distance) can also be determined depending an amount of received infrared rays. In this manner, the eye-touch sensing unit 57 performs eye-touch detection to sense a proximity distance of the object to the eyepiece unit 16.

The mode selection switch 60 switches an operation mode of the system control unit 50 to any of a still image shooting mode, a movie shooting mode, and the like. Examples of modes included in the still image shooting mode include an auto shooting mode, an auto scene determination mode, an MF mode, an aperture priority mode (Av mode), a shutter speed priority mode (Tv mode), and a program AE mode (P mode). In addition, the examples include various scene modes serving as shooting scene-specific shooting settings, a custom mode, and the like. With the mode selection switch 60, the user can directly switch the mode to any of these modes. Also, after switching to a screen of a list of shooting modes has been performed once by the mode selection switch 60, any of the plurality of displayed modes may be selected to switch by using other operation members. Similarly, the movie shooting mode may include a plurality of modes.

The power source switch 72 switches ON and OFF of a power supply to the camera 100.

An operation unit 70 is an input unit configured to accept a user operation and is used to input various operation instructions to the system control unit 50. The operation unit 70 includes the shutter button 61, the touch panel 70a, the main electronic dial 71, the sub electronic dial 73, the four-way operative key 74, the SET button 75, the movie button 76, the M-Fn button 77, the playback button 79, the menu button 81, and the like.

The shutter button 61 includes a first shutter switch 62 and a second shutter switch 64. The first shutter switch 62 turns ON in a middle of an operation on the shutter button 61, that is so-called a half press (shooting preparation instruction), to generate a first shutter switch signal SW1. The system control unit 50 starts a shooting preparation, such as the AF processing, the AE processing, the AWB processing, and the EF processing, based on the first shutter switch signal SW1. The second shutter switch 64 turns ON upon completion of the operation on the shutter button 61, that is so-called a full press (shooting instruction), to generate a second shutter switch signal SW2. The system control unit 50 starts, based on the second shutter switch signal SW2, a series of shooting processing from readout of signals from the image capturing unit 22 to writing of the captured image to the recording medium 200 as an image file.

The touch panel 70a is a touch sensor configured to detect various types of touch operations on a display surface of the display unit 28 (operation surface of the touch panel 70a). The touch panel 70a and the display unit 28 can be integrally constituted. For example, the touch panel 70a is constituted such that light transmittance does not disturb display of the display unit 28 and is attached to an upper layer of a display surface of the display unit 28. Since input coordinates on the touch panel 70a and display coordinates on a display surface of the display unit 28 are associated with each other, such a graphical user interface (GUI) is realized that it looks as if the user can directly operate the screen displayed on the display unit 28.

Herein, a configuration example of the lens unit 150 will be described with reference to FIGS. 7A to 7G. One lens unit can be mounted to the camera 100, and any one of a plurality of types of the lens units described with reference to FIGS. 7A to 7G is mounted to the camera 100.

FIGS. 7A to 7F illustrate examples in which the F/C multi-use ring 155 is mounted to the lens barrel of the lens unit 150. In addition, FIG. 7G illustrates an example in which a focus ring 151 and a control ring 154 are mounted to the lens barrel of the lens unit 150 instead of the F/C multi-use ring 155.

The F/C multi-use ring 155, the AF/MF switch 152, and the F/C switch 153 are mounted to the lens unit 150 of FIG. 7A.

The F/C multi-use ring 155 and the F/C switch 153 are mounted to the lens unit 150 of FIG. 7B, but the AF/MF switch 152 is not mounted.

The F/C multi-use ring 155 and the AF/MF switch 152 are mounted to the lens unit 150 of FIG. 7C, but the F/C switch 153 is not mounted.

The F/C multi-use ring 155 is mounted to the lens unit 150 of FIG. 7D, but the AF/MF switch 152 and the F/C switch 153 are not mounted.

The F/C multi-use ring 155 and a tri-level switch 156 are mounted to the lens unit 150 of FIG. 7E, but the AF/MF switch 152 and the F/C switch 153 are not mounted. The tri-level switch 156 is a switch having three positions of AF, MF, and control (C). When the user switches the tri-level switch 156, switching of the F/C multi-use ring 155 and switching of the focus mode can be performed. In a case where the position of the tri-level switch 156 is set at AF, the F/C multi-use ring 155 operates as the focus ring, and the focus mode becomes AF. In a case where the position of the tri-level switch 156 is set at MF, the F/C multi-use ring 155 operates as the focus ring, and the focus mode becomes MF. In a case where the position of the tri-level switch 156 is set at C, the F/C multi-use ring 155 operates as the control ring, and the focus mode is according to the setting of the camera 100. In the present embodiment, the tri-level switch 156 is equivalent to an example of a predetermined operation unit.

The lens unit 150 of FIG. 7F is obtained by adding the control ring 154 to the lens unit 150 of FIG. 7A. In general, the control ring produces sound or sensation for each click operation to typically notify the user of the number of changes. On the other hand, the focus ring does not generally produce sound or sensation at the time of operations. Therefore, two rings of the control ring and the focus ring can be mounted to the lens barrel. It is noted however that to satisfy a desire to silently operate the control ring during movie shooting or the like, the F/C multi-use ring 155 can be operated as the control ring. Herein, the example has been described in which the control ring 154 is added to the lens unit 150 of FIG. 7A, but a configuration may be adopted in which the control ring 154 is added to the lens unit 150 of FIGS. 7B to 7E.

The focus ring 151, the control ring 154, and the AF/MF switch 152 are mounted to the lens unit 150 of FIG. 7G, and the F/C multi-use ring 155 is not mounted.

In a case where the F/C switch 153 or the tri-level switch 156 is not mounted to the lens barrel of the lens unit, switching of the F/C multi-use ring 155 can be performed on a setting screen displayed on the camera 100.

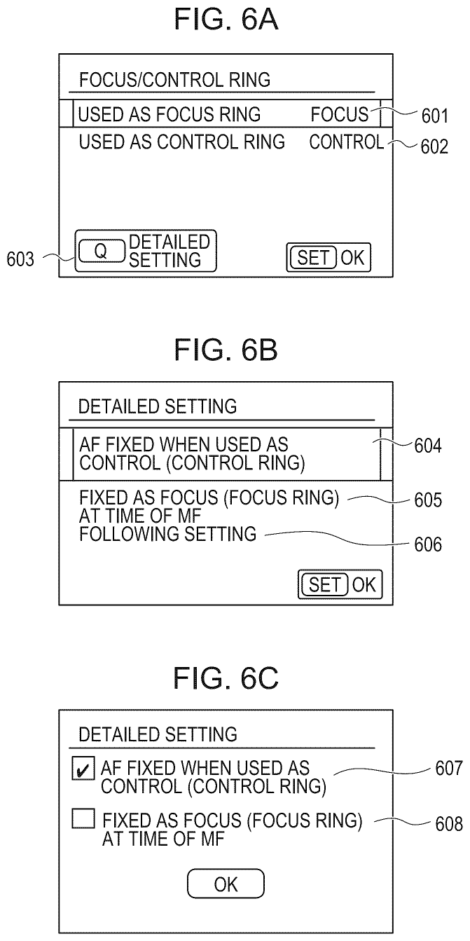

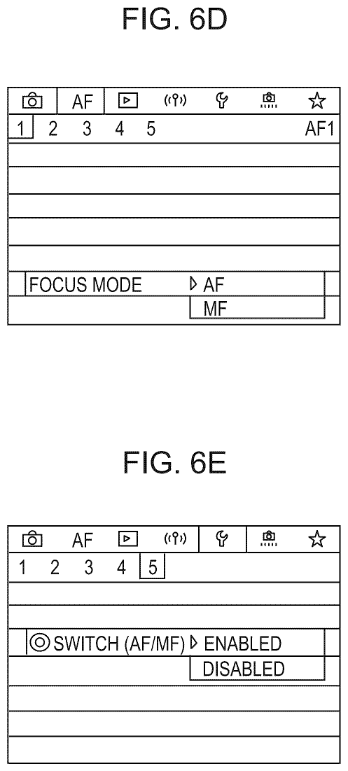

FIGS. 6A to 6E illustrate display examples of various setting screens displayed on the camera 100. The setting screens of FIGS. 6A to 6E are displayed on the display unit 28, the EVF 29, or the like of the camera 100. The user performs various types of settings by using the touch panel 70a, the main electronic dial 71, the sub electronic dial 73, the four-way operative key 74, the SET button 75, and the like. A value set on the setting screen is stored in the nonvolatile memory 56 of the camera 100.

FIG. 6A is an example of a setting screen displayed on the camera 100, and switching of the F/C multi-use ring 155 can be performed. Setting items 601 and 602, with which the user can select whether the F/C multi-use ring 155 is operated as the focus ring or operated as the control ring, are displayed on the setting screen. The user can select any of the setting items 601 and 602. When the setting item 601 is selected, the F/C multi-use ring 155 is set to be operated as the focus ring, and when the setting item 602 is selected, the F/C multi-use ring 155 is set to be operated as the control ring. It is noted that a transition section 603 for transitioning to a detailed setting screen is displayed on the setting screen of FIG. 6A.

FIG. 6B is an example of a detailed setting screen displayed on the camera 100 when the transition section 603 is selected. Setting items 604 to 606 are displayed on the detailed setting screen. The user can select any of the setting items 604 to 606.

When the setting item 604 is selected, the focus mode is set to be fixed to AF in a case where the F/C multi-use ring 155 is operated as the control ring. It is noted that when the selection of the setting item 604 is canceled, the setting of the focus mode to be fixed to AF is canceled.

When the setting item 605 is selected, the F/C multi-use ring 155 is set to fix the F/C multi-use ring 155 as the focus ring in a case where the focus mode is set as manual focus. It is noted that if the selection of the setting item 605 is canceled, the setting of the F/C multi-use ring 155 to fix the F/C multi-use ring 155 as the focus ring is canceled.

A setting is configured to avoid a state in which when the setting item 606 is selected, the focus mode is fixed to AF as if the setting item 604 is selected or the F/C multi-use ring 155 is fixed as the focus ring as if the setting item 605 is selected.

It is noted that in an initial display (initial setting), the setting item 604 is selected. Therefore, in a case where the F/C multi-use ring 155 is operated as the control ring, normally, the focus mode is fixed to AF. On the other hand, in a case where the F/C multi-use ring 155 is mounted to the lens unit but the focus ring is not mounted, the focus adjustment is not to be performed when the F/C multi-use ring 155 is operated as the control ring. Since the focus adjustment is not to be performed even when the focus mode is MF, basically, in a case where the F/C multi-use ring 155 is operated as the control ring, the focus mode is fixed to AF. It is noted however that when the user intentionally selects the setting item 605 or 606 instead of the setting item 604, the state in which the focus mode is fixed to AF can be cancelled.

It is noted however that in the initial display (initial setting), the configuration is not limited to a case where the setting item 604 is selected, and the setting item 605 may be selected. In this case, when the focus mode is set as manual focus, the F/C multi-use ring 155 is fixed as the focus ring.

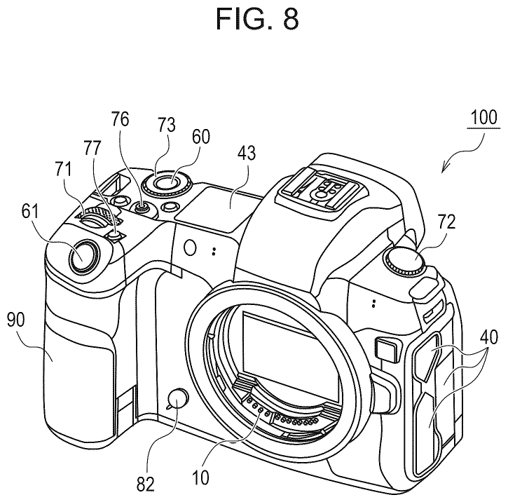

It is noted that, as illustrated in FIG. 8, an AF/MF switch 82 may be mounted to the camera 100. In this case, as illustrated in FIG. 6E, the AF/MF switch 82 can be switched to be enabled or disabled on the setting screen displayed on the camera 100. In a case where the AF/MF switch 82 is set as enabled, the focus mode can be set by the AF/MF switch 82. On the other hand, in a case where the AF/MF switch 82 is set as disabled, the AF/MF switch 82 does not affect a state of the camera 100, and a wrong operation of the AF/MF switch 82 can be avoided. It is noted that the configuration is adopted in which the AF/MF switch 82 is switched to be enabled or disabled, but a configuration may be adopted in which the setting of the focus mode and the setting other than the focus mode are switched. In addition, a configuration may be adopted in which the AF/MF switch 82 can be customized, and a configuration may be adopted in which disabling is not allowed.

In addition, as illustrated in FIG. 6B, the focus mode may be switched to AF or MF on the setting screen displayed on the camera 100 instead of the AF/MF switch 82. It is noted that the configuration is not limited to a case of the replacement of the AF/MF switch 82, in a case where the AF/MF switch 82 is mounted but the AF/MF switch 82 is set as disabled, the focus mode may be switched to AF or MF on the setting screen.

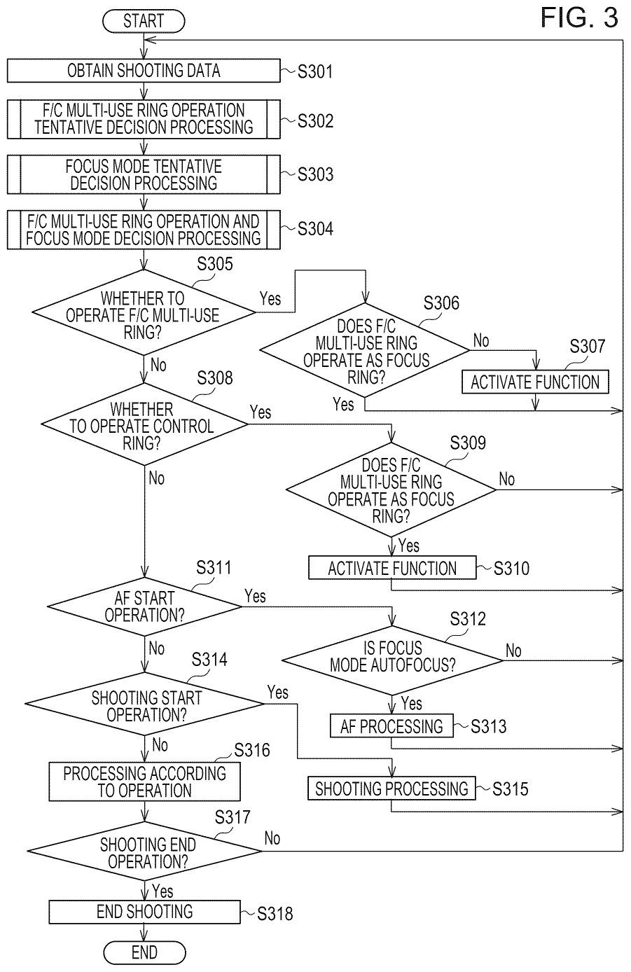

FIG. 3 is a flowchart illustrating an example of processing executed by the camera 100 according to the present embodiment. The flowchart of FIG. 3 is realized when the system control unit 50 expands and executes the program stored in the nonvolatile memory 56 into the system memory 52. In addition, the flowchart of FIG. 3 is started when the camera 100 activates or exits from the menu screen or the playback screen and transitions to a shooting standby state in which a shooting standby screen is displayed.

In step S301, the system control unit 50 obtains data demanded for shooting, such as an AF mode, an ISO, and a white balance, from the nonvolatile memory 56. In addition, the system control unit 50 obtains data such as a shutter speed or an aperture value calculated based on photometric information or the like. In addition, the system control unit 50 obtains, via the communication terminals 6 and 10, data such as a focal distance held by the lens unit 150 or a state of a switch.

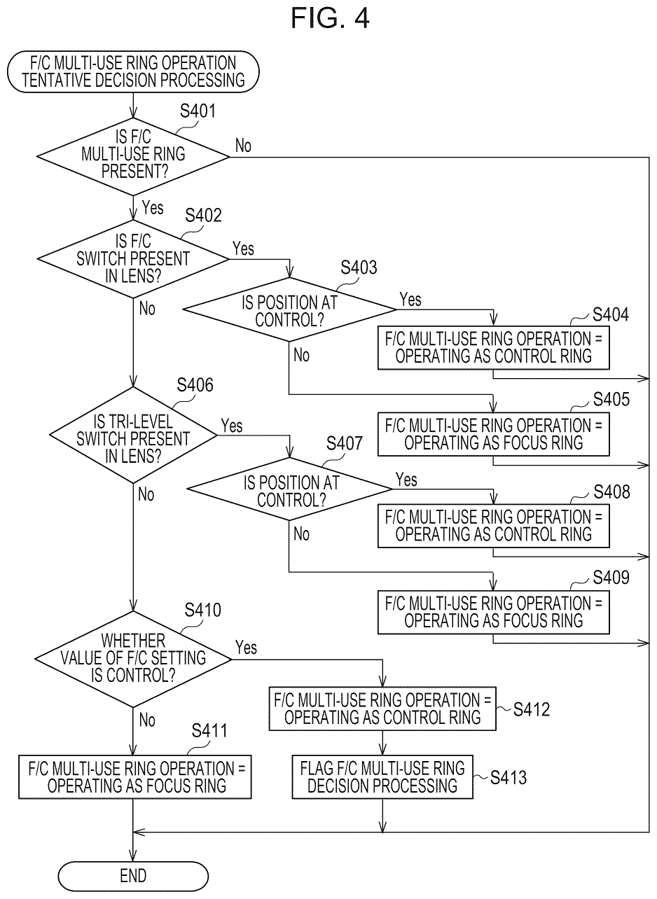

In step S302, the system control unit 50 tentatively decides whether the F/C multi-use ring 155 mounted to the lens unit 150 is operated as the focus ring or is operated as the control ring. The F/C multi-use ring operation tentative decision processing in step S302 will be described below with reference to FIG. 4.

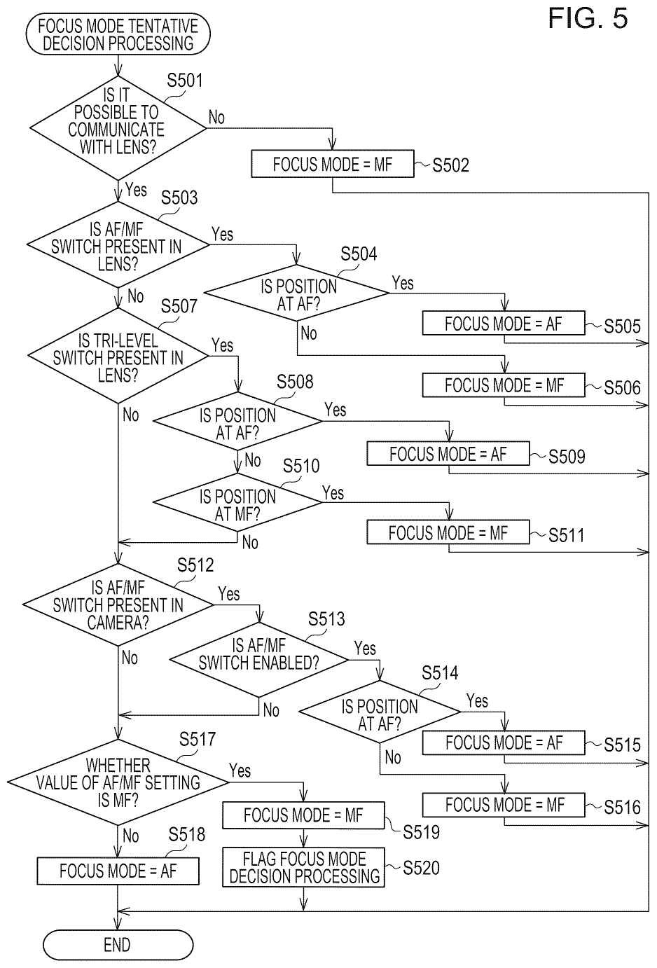

In step S303, the system control unit 50 tentatively decides whether the focus mode is set to AF or set to MF. Focus mode tentative decision processing in step S303 will be described below with reference to FIG. 5.

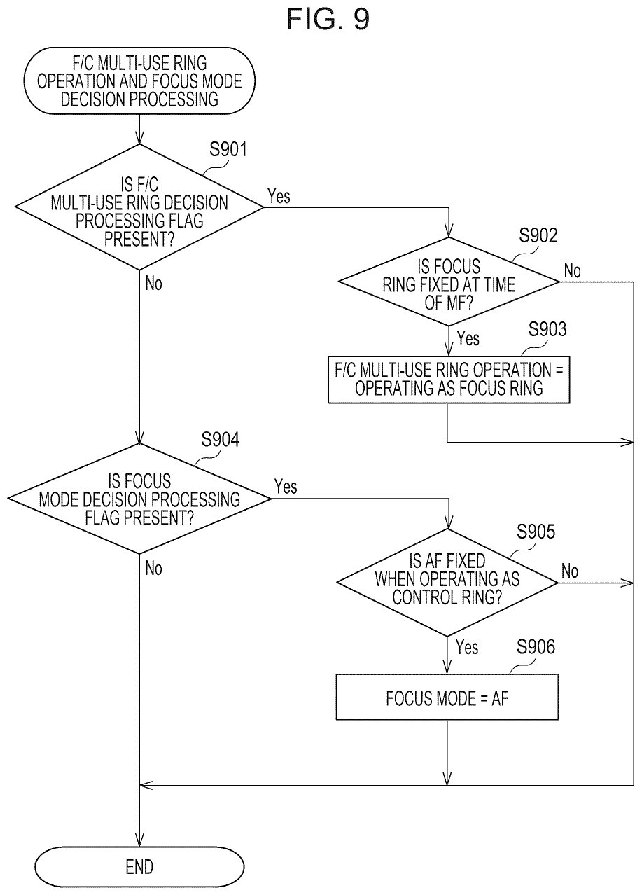

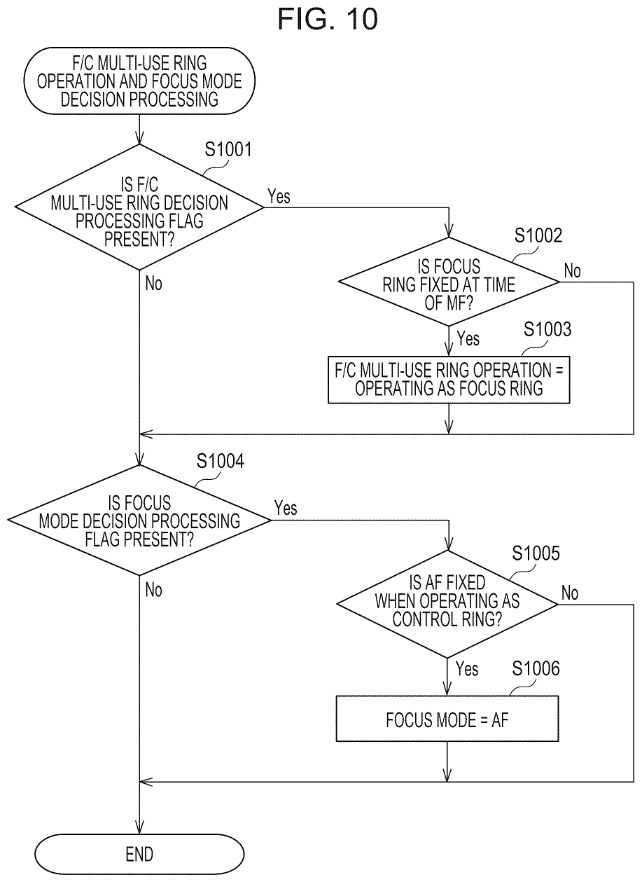

In step S304, the system control unit 50 decides whether the F/C multi-use ring 155 mounted to the lens unit 150 is operated as the focus ring or operated as the control ring. In addition, the system control unit 50 decides whether the focus mode is set to AF or is set to MF. The decision processing of the F/C multi-use ring operation and the focus mode in step S304 will be described below with reference to FIG. 9.

In step S305, the system control unit 50 determines whether or not the F/C multi-use ring 155 is operated. In a case where the F/C multi-use ring 155 is operated, the flow transitions to step S306. On the other hand, in a case where the F/C multi-use ring 155 is not operated, the flow transitions to step S308.

In step S306, the system control unit 50 determines whether or not the F/C multi-use ring 155 operates as the focus ring based on an operation that the F/C multi-use ring 155 (an operation that was decided in step S304) is caused to perform. In a case where the F/C multi-use ring 155 operates as the focus ring, the flow transitions to step S301.

Herein, in a case where the focus mode is MF, the system control unit 50 executes focus movement processing according to the operation of the F/C multi-use ring 155. It is noted however that since the focus movement processing is closed and controlled on the lens unit 150 side, the system control unit 50 does not perform the processing and then instructs the lens system control circuit 4 to perform the focus movement processing. When the lens system control circuit 4 executes the focus movement processing in the lens unit 150, the focus movement processing is executed as the entire image capturing apparatus including the lens unit 150.

In addition, in a case where the focus mode is AF, the system control unit 50 may be configured to avoid executing the focus movement processing even when the F/C multi-use ring 155 is operated and may execute the focus movement processing according to the operation of the F/C multi-use ring 155. The system control unit 50 can change whether or not, in a case where the focus mode is AF, the focus movement processing is to be executed based on a setting that is not illustrated in the drawing according to the user operation.

On the other hand, in a case where the F/C multi-use ring 155 does not operate as the focus ring, that is, operates as the control ring, the flow transitions to step S307.

In step S307, the system control unit 50 activates the function allocated to the control ring, and the flow transitions to step S301.

Herein, as in the lens unit 150 of FIG. 7F, the F/C multi-use ring 155 and the control ring 154 may be mounted to the lens unit 150. In the lens unit 150 described above, in a case where the F/C multi-use ring 155 is operated as the control ring, the control ring 154 is preferably configured not to be operated to avoid a wrong operation. In steps S308 to S310, this processing will be described.

In step S308, the system control unit 50 determines whether or not the control ring 154 mounted to the lens unit 150 is operated. In a case where the control ring 154 is operated, the flow transitions to step S309. On the other hand, in a case where the control ring 154 is not operated, the flow transitions to step S311.

In step S309, the system control unit 50 determines whether or not the F/C multi-use ring 155 operates as the focus ring based on the operation decided in step S304 that the F/C multi-use ring 155 is caused to perform. In a case where the F/C multi-use ring 155 operates as the focus ring, the flow transitions to step S310. On the other hand, in a case where the F/C multi-use ring 155 does not operate as the focus ring, that is, operates as the control ring, the flow transitions to step S301.

In step S310, the system control unit 50 activates the function allocated to the control ring 154, and the flow transitions to step S301.

In step S311, the system control unit 50 determines whether or not the AF processing start operation is performed according to whether or not the first shutter switch signal SW1 is generated through the half press of the shutter button 61. In a case where the AF processing start operation is performed, the flow transitions to step S312. On the other hand, in a case where the AF processing start operation is not performed, the flow transitions to step S314.

In step S312, the system control unit 50 refers to the focus mode decided in step S304, and in a case where the focus mode is autofocus, the flow transitions to step S313. On the other hand, in a case where the focus mode is not autofocus, that is, a case where the focus mode is manual focus, the flow transitions to step S301.

In step S313, the system control unit 50 starts the AF processing, and the flow transitions to step S301.

In step S314, the system control unit 50 determines whether or not a shooting start operation is performed according to whether or not the second shutter switch signal SW2 is generated through the full press of the shutter button 61. In a case where the shooting start operation is performed, the flow transitions to step S315. On the other hand, in a case where the shooting start operation is not performed, the flow transitions to step S316.

In step S315, the system control unit 50 performs shooting processing, and the flow transitions to step S301.

In step S316, the system control unit 50 performs processing according to the operation.

In step S317, the system control unit 50 determines whether or not a shooting end operation is performed. In a case where the shooting end operation is performed, the flow transitions to step S318. On the other hand, in a case where the shooting end operation is not performed, the flow transitions to step S301.

In step S318, the system control unit 50 performs shooting end processing and ends the flowchart of FIG. 3.

Next, a detail of the F/C multi-use ring operation tentative decision processing in step S302 of FIG. 3 will be described with reference to FIG. 4.

In step S401, the system control unit 50 determines whether or not the F/C multi-use ring 155 is present in the lens unit 150. In a case where the F/C multi-use ring 155 is present, the flow transitions to step S402. Since the F/C multi-use ring 155 is present in the lens unit 150 of FIGS. 7A to 7F, the flow transitions to step S402. On the other hand, in a case where the F/C multi-use ring 155 is absent, the flowchart of FIG. 4 is ended. Since the F/C multi-use ring 155 is absent in the lens unit 150 of FIG. 7G, the flowchart of FIG. 4 is ended.

In step S402, the system control unit 50 determines whether or not the F/C switch 153 is present in the lens unit 150. In a case where the F/C switch 153 is present, the flow transitions to step S403. Since the F/C switch 153 is present in the lens unit 150 of FIGS. 7A, 7B, and 7F, the flow transitions to step S403. On the other hand, in a case where the F/C switch 153 is absent, the flow transitions to step S406. Since the F/C switch 153 is absent in the lens unit 150 of FIGS. 7C, 7D, and 7E, the flow transitions to step S406.

In step S403, the system control unit 50 determines whether or not the position of the F/C switch 153 is set at control. In a case where the position of the F/C switch 153 is set at control, the flow transitions to step S404. On the other hand, in a case where the position of the F/C switch 153 is not set at control, that is, a case where the position is set at focus, the flow transitions to step S405.

In step S404, the system control unit 50 configures the setting such that the F/C multi-use ring 155 operates as the control ring and ends the flowchart of FIG. 4.

In step S405, the system control unit 50 configures the setting such that the F/C multi-use ring 155 operates as the focus ring and ends the flowchart of FIG. 4.

In this manner, in the lens unit 150 of FIGS. 7A, 7B, and 7F, the operation of the F/C multi-use ring 155 is as indicated by the position of the F/C switch 153.

In step S406, the system control unit 50 determines whether or not the tri-level switch 156 is present in the lens unit 150. In a case where the tri-level switch 156 is present, the flow transitions to step S407. Since the tri-level switch 156 is present in the lens unit 150 of FIG. 7E, the flow transitions to step S407. On the other hand, in a case where the tri-level switch 156 is absent, the flow transitions to step S410. Since the tri-level switch 156 is absent in the lens unit 150 of FIGS. 7C and 7D, the flow transitions to step S410.

In step S407, the system control unit 50 determines whether or not the position of the tri-level switch 156 is set at control. In a case where the position of the tri-level switch 156 is set at control, the flow transitions to step S408. On the other hand, in a case where the position of the tri-level switch 156 is not set at control, that is, a case where the position is set at AF or MF, the flow transitions to step S409.

In step S408, the system control unit 50 configures the setting such that the F/C multi-use ring 155 operates as the control ring and ends the flowchart of FIG. 4.

In step S409, the system control unit 50 configures the setting such that the F/C multi-use ring 155 operates as the focus ring and ends the flowchart of FIG. 4.

In this manner, in the lens unit 150 of FIG. 7E, the operation of the F/C multi-use ring 155 is as indicated by the position of the tri-level switch 156.

As in the lens unit 150 of FIGS. 7C and 7D, in a case where none of the F/C switch 153 and the tri-level switch 156 is present in the lens unit 150, the operation of the F/C multi-use ring 155 is set on the setting screen displayed on the camera 100 as in FIG. 6A. Herein, a setting as to whether the F/C multi-use ring 155 is operated as the focus ring or is operated as the control ring on the setting screen displayed on the camera 100 is referred to as an F/C setting. In a case where the setting item 601 is selected by the F/C setting, the value of the F/C setting is stored as focus in the nonvolatile memory 56, and in a case where the setting item 602 is selected by the F/C setting, the value of the F/C setting is stored as control in the nonvolatile memory 56. In steps S410 to S413, the system control unit 50 performs processing using the value stored in the F/C setting.

In step S410, the system control unit 50 determines whether or not the value of the F/C setting stored in the nonvolatile memory 56 of the camera 100 is control. In a case where the value of the F/C setting is control, the flow transitions to step S412. On the other hand, in a case where the value of the F/C setting is not control, that is, a case where the value is focus, the flow transitions to step S411.

In step S411, the system control unit 50 configures the setting such that the F/C multi-use ring 155 operates as the focus ring and ends the flowchart of FIG. 4.

In step S412, the system control unit 50 configures the setting such that the F/C multi-use ring 155 operates as the control ring.

In step S413, the system control unit 50 flags F/C multi-use ring decision processing used in the decision processing of the F/C multi-use ring operation and the focus mode and ends the flowchart of FIG. 4. The decision processing of the F/C multi-use ring operation and the focus mode will be described below with reference to FIG. 9.

In this manner, in the lens unit 150 of FIGS. 7C and 7D, the operation of the F/C multi-use ring 155 is according to the setting on the setting screen as is.

Next, a detail of the focus mode tentative decision processing in step S303 of FIG. 3 will be described with reference to FIG. 5.

In step S501, the system control unit 50 determines whether or not it is possible to communicate with the lens unit 150 via the communication terminal 10. In a case where it is possible to communicate with the lens unit 150, the flow transitions to step S503. On the other hand, if it is not possible to communicate with the lens unit 150, the flow transitions to step S502. The following situations apply as a state in which the system control unit 50 is not to communicate with the lens unit 150. The state in which the system control unit 50 is not communicable includes, for example, a case where the lens unit 150 is not yet mounted or is not appropriately mounted to the camera 100, a case where the lens unit 150 is broken, a case where the lens unit 150 does not support the communication yet, and the like.

In step S502, since the AF control is not to be performed because it is not possible to communicate with the lens unit 150, the system control unit 50 sets the focus mode as MF and ends the flowchart of FIG. 5.

In step S503, the system control unit 50 determines whether or not the AF/MF switch 152 is present in the lens unit 150. In a case where the AF/MF switch 152 is present, the flow transitions to step S504. Since the AF/MF switch 152 is present in the lens unit 150 of FIGS. 7A, 7C, 7F, and 7G, the flow transitions to step S504. On the other hand, in a case where the AF/MF switch 152 is absent, the flow transitions to step S507. Since the AF/MF switch 152 is absent in the lens unit 150 of FIGS. 7B, 7D, and 7E, the flow transitions to step S507.

In step S504, the system control unit 50 determines whether or not a position of the AF/MF switch 152 is set at AF. In a case where the position of the AF/MF switch 152 is set at AF, the flow transitions to step S505. On the other hand, in a case where the position of the AF/MF switch 152 is not set at AF, that is, a case where the position is set at MF, the flow transitions to step S506.

In step S505, the system control unit 50 sets the focus mode at AF and ends the flowchart of FIG. 5.

In step S506, the system control unit 50 sets the focus mode at MF and ends the flowchart of FIG. 5.

In this manner, in the lens unit 150 of FIGS. 7A, 7C, 7F, and 7G, the focus mode is as indicated by the position of the AF/MF switch 152.

In step S507, the system control unit 50 determines whether or not the tri-level switch 156 is present in the lens unit 150. In a case where the tri-level switch 156 is present, the flow transitions to step S508. Since the tri-level switch 156 is present in the lens unit 150 of FIG. 7E, the flow transitions to step S508. On the other hand, in a case where the tri-level switch 156 is absent, the flow transitions to step S512. Since the tri-level switch 156 is absent in the lens unit 150 of FIGS. 7B and 7D, the flow transitions to step S512.

In step S508, the system control unit 50 determines whether or not the position of the tri-level switch 156 is set at AF. In a case where the position of the tri-level switch 156 is set at AF, the flow transitions to step S509. On the other hand, in a case where the position of the tri-level switch 156 is not set at AF, the flow transitions to step S510.

In step S509, the system control unit 50 sets the focus mode at AF and ends the flowchart of FIG. 5.

In step S510, the system control unit 50 determines whether or not the position of the tri-level switch 156 is set at MF. In a case where the position of the tri-level switch 156 is set at MF, the flow transitions to step S511. On the other hand, in a case where the position of the tri-level switch 156 is not set at MF, the flow transitions to step S512.

In step S511, the system control unit 50 sets the focus mode at MF and ends the flowchart of FIG. 5.

In the lens unit 150 of FIG. 7E, when the position of the tri-level switch 156 is set at AF or MF, the focus mode is as indicated by the position of the tri-level switch 156. On the other hand, when the position of the tri-level switch 156 is set at control, the flow transitions to step S512.

In this manner, in a case where the AF/MF switch 152 or the tri-level switch 156 is mounted to the lens unit 150, the focus mode is set by the AF/MF switch 152 or the tri-level switch 156.

In step S512, the system control unit 50 determines whether or not the AF/MF switch 82 is present in the camera 100. As illustrated in FIG. 8, in a case where the AF/MF switch 82 is present, the flow transitions to step S513. On the other hand, in a case where the AF/MF switch 82 is absent, the flow transitions to step S517.

In step S513, the system control unit 50 determines whether or not the AF/MF switch 82 is set as enabled. As illustrated in FIG. 6E, the AF/MF switch 82 can be set as enabled or disabled on the setting screen. In a case where the AF/MF switch 82 is set as enabled, the flow transitions to step S514. In a case where the AF/MF switch 82 is not set as enabled, that is, a case where the AF/MF switch 82 is set as disabled, the flow transitions to step S517.

In step S514, the system control unit 50 determines whether or not the position of the AF/MF switch 82 is set at AF. In a case where the position of the AF/MF switch 82 is set at AF, the flow transitions to step S515. On the other hand, in a case where the position of the AF/MF switch 82 is not set at AF, that is, a case where the position is set at MF, the flow transitions to step S516.

In step S515, the system control unit 50 sets the focus mode at AF and ends the flowchart of FIG. 5.

In step S516, the system control unit 50 sets the focus mode at MF and ends the flowchart of FIG. 5.

In this manner, in a case where the AF/MF switch 152 and the tri-level switch 156 are not mounted to the lens unit 150, when the AF/MF switch 82 is enabled, the focus mode is set by the AF/MF switch 82. In a case where the tri-level switch 156 is present but the position of the tri-level switch 156 is set at control, when the AF/MF switch 82 is enabled, the focus mode is set by the AF/MF switch 82.

In step S517, the system control unit 50 determines whether or not the value of the AF/MF setting stored in the nonvolatile memory 56 of the camera 100 is MF. Herein, as in FIG. 6D, a setting to select AF or MF on the setting screen displayed on the camera 100 is referred to as an AF/MF setting. The value selected in the AF/MF setting is stored in the nonvolatile memory 56. In a case where the value of the AF/MF setting is not MF, that is, a case where the value is AF, the flow transitions to step S518. On the other hand, in a case where the value of the AF/MF setting is MF, the flow transitions to step S519.

In step S518, the system control unit 50 sets the focus mode as AF according to the AF/MF setting as is and ends the flowchart of FIG. 5.

In step S519, the system control unit 50 sets the focus mode as MF.

In step S520, the system control unit 50 flags the focus mode decision processing used in the decision processing of the F/C multi-use ring operation and the focus mode and ends the flowchart of FIG. 5. The decision processing of the F/C multi-use ring operation and the focus mode will be described below with reference to FIG. 9.

Next, a detail of the decision processing of the F/C multi-use ring operation and the focus mode in step S304 of FIG. 3 will be described below with reference to FIG. 9.

In step S901, the system control unit 50 determines whether or not the F/C multi-use ring decision processing is flagged in step S413 of FIG. 4. In a case where the flag is present, the flow transitions to step S902. On the other hand, in a case where the flag is absent, the flow transitions to step S904.

In step S902, the system control unit 50 determines whether or not a selection is made to fix the F/C multi-use ring 155 as the focus ring at the time of manual focus. Specifically, the system control unit 50 determines whether or not the setting item 605 to fix the F/C multi-use ring 155 as the focus ring is selected on the setting screen of FIG. 6B. In a case where the selection is made to fix the F/C multi-use ring 155 as the focus ring, the flow transitions to step S903. On the other hand, in a case where the selection is not made to fix the F/C multi-use ring 155 as the focus ring, the flowchart of FIG. 9 is ended.

In step S903, the system control unit 50 sets the F/C multi-use ring 155 to operate as the focus ring and ends the flowchart of FIG. 9. That is, the system control unit 50 controls the F/C multi-use ring 155 to operate as the focus ring irrespective of the F/C setting.

In step S904, the system control unit 50 determines whether or not the focus mode decision processing is flagged in step S520 of FIG. 5. In a case where the flag is present, the flow transitions to S905. On the other hand, in a case where the flag is absent, the flowchart of FIG. 9 is ended.

In step S905, the system control unit 50 determines whether or not the selection is made to fix the focus mode to AF in a case where the F/C multi-use ring 155 is used as the control ring. Specifically, the system control unit 50 determines whether or not the setting item 604 to fix the focus mode to AF is selected on the setting screen of FIG. 6B. In a case where the selection to fix the focus mode to AF is made, the flow transitions to step S906. On the other hand, in a case where the selection to fix the focus mode to AF is not made, the flowchart of FIG. 9 is ended.

In step S906, the system control unit 50 sets the focus mode as AF and ends the flowchart of FIG. 9. That is, the system control unit 50 controls the focus mode to be set as AF irrespective of the setting of the focus mode in the AF/MF setting.

As described above, according to the present embodiment, when the focus mode is manual focus, the system control unit 50 controls the F/C multi-use ring 155 to operate as the focus ring. Under the control described above, such a combination is not established in which the focus mode is set as MF and the F/C multi-use ring 155 operates as the control ring. Therefore, such an inconvenience can be avoided that even when the focus mode is MF, it become difficult to quickly establish a focused state from a blurred state by using the F/C multi-use ring 155. In addition, a loss of operability can be avoided without needing an operation of switching the F/C multi-use ring 155 to operate as the focus ring or switching the focus mode to AF. Therefore, the camera 100 of the present embodiment can remove complications caused by the combination of the setting of the F/C multi-use ring 155 and the focus mode.

In addition, according to the present embodiment, the F/C switch 153 and the tri-level switch 156 are mounted to the lens unit 150. In a case where the F/C multi-use ring 155 is explicitly uniquely set by these physical switches, even when the focus mode is set as MF, the F/C setting set by these physical switches is adopted as is. In a case where the F/C multi-use ring 155 is set as the control ring by these physical switches, the F/C multi-use ring 155 is not set as the focus ring but is set as the control ring. In this manner, in a case where the operation of the F/C multi-use ring 155 is set by these physical switches, the user is conscious on whether the F/C multi-use ring 155 operates as the focus ring or operates as the control ring. Therefore, the consciousness of the user can be prioritized since automatic control for causing the F/C multi-use ring 155 to operate as the focus ring is not to be performed.

On the other hand, in a case where the F/C switch 153 and the tri-level switch 156 are absent, when the focus mode is set as MF, even when the control ring is set by the F/C setting, the F/C multi-use ring 155 is controlled to operate as the focus ring.

It is noted that the configuration is not limited to the control described in the present embodiment, and irrespective of how the F/C multi-use ring 155 is set, when the focus mode is MF, the F/C multi-use ring may be operated in the focus mode.

In addition, according to the present embodiment, in FIG. 6B, the case has been described where the setting can be configured to fix the focus mode to AF when the F/C multi-use ring 155 is operated as the control ring, but some embodiments of the present disclosure are not limited to this. For example, the focus mode may be fixed to AF in a case where the F/C multi-use ring 155 is operated as the control ring without the setting.

In addition, according to the present embodiment, the configuration has been described in which the lens unit 150 can be detachably attached to the camera 100, but the camera and the lens may be constructed as a single unit.

In addition, according to the present embodiment, the case has been described where the multi-use operation member is the F/C multi-use ring 155 mounted to the lens unit 150, but, for example, the multi-use operation member may be an operation member mounted on the camera 100 side.

In addition, according to the present embodiment, the case has been described where the F/C switch 153 is mounted to the lens unit 150, but, for example, the F/C switch 153 may be mounted on the camera 100 side.

In addition, a configuration may be adopted in which the setting value stored in the camera 100 is stored by a control apparatus configured to remotely control the camera 100 via a wired or wireless communication. Examples of the control apparatus configured to remotely control the camera 100 include, for example, an apparatus such as a smartphone, a tablet personal computer (PC), or a desktop PC.

Second Embodiment

According to a second embodiment, differences from the first embodiment will be mainly described. According to the second embodiment, a setting screen of FIG. 6C is displayed instead of the setting screen of FIG. 6B described in the first embodiment.

FIG. 6C is an example of a detailed setting screen displayed on the camera 100 when the transition section 603 is selected. The setting items 607 and 608 are displayed on the detailed setting screen. A checkbox is displayed for each of the setting items 607 and 608, and the user can select whether or not a setting is to be configured for each of the setting items 607 and 608.

When the checkbox of the setting item 607 is selected, the setting is configured to fix the focus mode to AF in a case where the F/C multi-use ring 155 is operated as the control ring. On the other hand, when the selection of the checkbox of the setting item 607 is cancelled, the setting to fix the focus mode to AF is cancelled.

When the checkbox of the setting item 608 is selected, a setting is configured to fix the F/C multi-use ring 155 as the focus ring when the focus mode is set as manual focus. On the other hand, when the selection of the checkbox of the setting item 608 is cancelled, the setting to fix the F/C multi-use ring 155 as the focus ring is cancelled.

Therefore, it is possible to simultaneously configure the setting to fix the focus mode to AF in a case where the F/C multi-use ring 155 is operated as the control ring and the setting to fix the F/C multi-use ring 155 as the focus ring when the focus mode is set as manual focus.

It is noted that in the initial display (initial setting), the setting item 607 is selected. Therefore, in a case where the F/C multi-use ring 155 is operated as the control ring, the focus mode is normally fixed to AF. On the other hand, in a case where the F/C multi-use ring 155 is mounted to the lens unit but the focus ring is not mounted, the focus adjustment is not to be performed in a case where the F/C multi-use ring 155 is operated as the control ring. Since the focus adjustment is not to be performed even when the focus mode is MF, basically, in a case where the F/C multi-use ring 155 is operated as the control ring, the focus mode is fixed to AF. It is noted however that when the user intentionally performs an operation of cancelling the selection of the checkbox of the setting item 607, the state in which the focus mode is fixed to AF can be cancelled.

Next, a detail of the decision processing of the F/C multi-use ring operation and the focus mode in step S304 of FIG. 3 will be described with reference to FIG. 10.

In step S1001, the system control unit 50 determines whether or not the F/C multi-use ring decision processing is flagged in step S413 of FIG. 4. In a case where the flag is present, the flow transitions to S1002. On the other hand, in a case where the flag is absent, the flow transitions to S1004.

In step S1002, the system control unit 50 determines whether or not a selection is made to fix the F/C multi-use ring 155 as the focus ring at the time of manual focus. Specifically, the system control unit 50 determines whether or not the checkbox of the setting item 608 to fix the F/C multi-use ring 155 as the focus ring is selected on the setting screen of FIG. 6C. In a case where the selection to fix the F/C multi-use ring 155 as the focus ring is made, the flow transitions to step S1003. On the other hand, in a case where the selection to fix the F/C multi-use ring 155 as the focus ring is not made, the flow transitions to step S1004.

In step S1003, the system control unit 50 sets the F/C multi-use ring 155 to operate as the focus ring, and the flow transitions to step S1004. That is, irrespective of the F/C setting, the system control unit 50 controls the F/C multi-use ring 155 to operate as the focus ring.

In step S1004, the system control unit 50 determines whether or not the focus mode decision processing is flagged in step S520 of FIG. 5. In a case where the flag is present, the flow transitions to S1005. On the other hand, in a case where the flag is absent, the flowchart of FIG. 10 is ended.

In step S1005, the system control unit 50 determines whether or not the selection is made to fix the focus mode to AF in a case where the F/C multi-use ring 155 is used as the control ring. Specifically, the system control unit 50 determines whether or not the checkbox of the setting item 607 to fix the focus mode to AF is selected on the setting screen of FIG. 6C. In a case where the selection to fix the focus mode to AF is made, the flow transitions to step S1006. On the other hand, in a case where the selection to fix the focus mode to AF is not made, the flowchart of FIG. 10 is ended.

In step S1006, the system control unit 50 sets the focus mode as AF and ends the flowchart of FIG. 10. That is, the system control unit 50 controls the focus mode to be set as AF irrespective of the setting of the focus mode in the AF/MF setting.

### Third Embodiment

According to a third embodiment, differences from the first embodiment and the second embodiment will be mainly described.

The lens unit 150 includes a lens (center focus macro lens) enabling macro shooting to perform shooting by approaching a subject. The system control unit 50 determines whether or not the lens unit 150 is a center focus macro lens based on lens identification information received from the mounted lens unit 150. In a case where the lens unit 150 is a center focus macro lens, the system control unit 50 sets the F/C multi-use ring 155 to operate as the focus ring.

Specifically, the third embodiment can be realized by replacing step S902 in the flowchart of FIG. 9 with the following processing.

In step S902, the system control unit 50 determines whether or not the mounted lens unit 150 is a center focus macro lens, the focus mode is set as AF, and the focal distance is closer than a threshold. In a case where all the conditions are satisfied, the flow transitions to step S903. On the other hand, if any of the conditions is not satisfied, the flowchart of FIG. 9 is ended.

When the flow transitions to step S903, since the F/C multi-use ring 155 is set to be operated as the focus ring, even when the control ring is set by the F/C setting, the F/C multi-use ring 155 is controlled to operate as the focus ring.

It is noted that step S902 of the third embodiment is not limited to the above-described processing, and the system control unit 50 may determine only whether or not the mounted lens unit 150 is a center focus macro lens. In addition, in step S902 of the third embodiment, the system control unit 50 may determine the mounted lens unit 150 is a center focus macro lens and the focal distance is closer than a threshold.

In addition, step S903 of the third embodiment may be applied to step S1002 of the second embodiment.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-066051, which was filed on Apr. 16, 2024 and which is hereby incorporated by reference herein in its entirety.

What is claimed is:

1. An image capturing apparatus comprising:
at least one processor; and
at least one memory that is in communication with the at least one processor, wherein the at least one memory stores instructions for causing the at least one processor and the at least one memory to:
allow a focus mode to be set as autofocus to automatically focus on a subject or as manual focus to manually focus on a subject; and
control a multi-use operation member capable of switching to be operated as a first operation member for manual focus operation or operated as a second operation member for operation other than the manual focus operation, to be operated as the first operation member when the focus mode is manual focus.

2. The image capturing apparatus according to claim 1, wherein the at least one memory further stores instructions for causing the at least one processor and the at least one memory to:
in a case where the multi-use operation member is set to be operated as the second operation member by a predetermined operation unit, even when the focus mode is manual focus, control the multi-use operation member to be operated as the second operation member and not to be operated as the first operation member.

3. The image capturing apparatus according to claim 2, wherein the at least one memory further stores instructions for causing the at least one processor and the at least one memory to:
in a case where the predetermined operation unit is absent and the multi-use operation member is set to be operated as the second operation member by a setting unit different from the predetermined operation unit, when the focus mode is manual focus, control the multi-use operation member to be operated as the first operation member irrespective of the setting by the setting unit.

4. The image capturing apparatus according to claim 1,
wherein the at least one memory further stores instructions for causing the at least one processor and the at least one memory to select whether or not the multi-use operation member is fixed as the first operation member when the focus mode is manual focus.

5. The image capturing apparatus according to claim 4,
wherein the at least one memory further stores instructions for causing the at least one processor and the at least one memory to:
control the multi-use operation member to be operated as the first operation member when the focus mode is manual focus in a case where the first selection unit selects that the multi-use operation member is fixed as the first operation member when the focus mode is manual focus, and
control the multi-use operation member to be operated as the first operation member or the second operation member when the focus mode is manual focus in a case where the first selection unit does not select that the multi-use operation member is fixed as the first operation member when the focus mode is manual focus.

6. The image capturing apparatus according to claim 4,
wherein the at least one memory further stores instructions for causing the at least one processor and the at least one memory to:
select whether or not the focus mode is fixed to autofocus when the multi-use operation member is operated as the second operation member,
select that the multi-use operation member is fixed as the first operation member when the focus mode is manual focus, and
select that the focus mode is fixed to autofocus when the multi-use operation member is operated as the second operation member.

7. The image capturing apparatus according to claim 1, further comprising:
a lens unit,
wherein the multi-use operation member is an operation member provided on the lens unit.

8. The image capturing apparatus according to claim 7, wherein the multi-use operation member is a ring provided on a lens barrel.

9. The image capturing apparatus according to claim 1,
wherein a first lens unit is mountable, and wherein the first lens unit includes the multi-use operation member and a predetermined operation unit configured to set an operation on the multi-use operation member according to a user operation.

10. The image capturing apparatus according to claim 9,
wherein a second lens unit is mountable, and wherein the second lens unit includes the multi-use operation member and does not include the predetermined operation unit.

11. The image capturing apparatus according to claim 10,
wherein the at least one memory further stores instructions for causing the at least one processor and the at least one memory to:
control the multi-use operation member of the first lens unit to be operated as the first operation member or the second operation member based on a setting by the predetermined operation unit irrespective of whether or not the focus mode is manual focus in a case where the first lens unit is mounted, and
control the multi-use operation member of the second lens unit to be operated as the first operation member when the focus mode is manual focus in a case where the second lens unit is mounted.

12. The image capturing apparatus according to claim 11,
wherein the at least one memory further stores instructions for causing the at least one processor and the at least one memory to:
set the multi-use operation member to be operated as the first operation member or the second operation member via a setting screen, and
control the multi-use operation member of the second lens unit to be operated as the first operation member irrespective of a setting by the first setting unit when the focus mode is manual focus in a case where the second lens unit is mounted.

13. The image capturing apparatus according to claim 12,
wherein the at least one memory further stores instructions for causing the at least one processor and the at least one memory to:
set the multi-use operation member to be fixed as the first operation member via the setting screen when the focus mode is manual focus, and
control the multi-use operation member of the second lens unit to be operated as the first operation member irrespective of a setting by the first setting unit when the focus mode is manual focus and the second setting unit sets the multi-use operation member to be fixed as the first operation member in a case where the second lens unit is mounted.

14. The image capturing apparatus according to claim 9,
wherein the predetermined operation unit is a switch which is provided on a lens barrel of the first lens unit and which is capable of switching the multi-use operation member to be operated as the first operation member or operated as the second operation member.

15. The image capturing apparatus according to claim 9,
wherein the predetermined operation unit is a switch which is provided on a lens barrel of the first lens unit and which is capable of being switched to any of three positions in which the focus mode is set as manual focus, the focus mode is set as autofocus, and the multi-use operation member is operated as the second operation member.

16. An image capturing apparatus comprising:
at least one processor; and
at least one memory that is in communication with the at least one processor, wherein the at least one memory stores instructions for causing the at least one processor and the at least one memory to:
allow a focus mode to be set as autofocus to automatically focus on a subject or as manual focus to manually focus on a subject; and
control a multi-use operation member capable of switching to be operated as a first operation member for manual focus operation or operated as a second operation member for operation other than the manual focus operation, to be operated as the first operation member when a predetermined lens unit is mounted.

17. The image capturing apparatus according to claim 16, wherein the at least one memory further stores instructions for causing the at least one processor and the at least one memory to:
in a case where a setting unit sets the multi-use operation member to be operated as the second operation member, when the predetermined lens unit is mounted, control the multi-use operation member to be operated as the first operation member irrespective of the setting by the setting unit.

18. The image capturing apparatus according to claim 16, wherein the predetermined lens unit is a lens enabling macro shooting.

19. A non-transitory computer-readable medium for causing a computer to execute a control method for an image capturing apparatus, the control method for the image capturing apparatus comprising:
allowing a focus mode to be set as autofocus to automatically focus on a subject or as manual focus to manually focus on a subject; and
controlling a multi-use operation member capable of switching to be operated as a first operation member for manual focus operation or operated as a second operation member for operation other than the manual focus operation, to be operated as the first operation member when the focus mode is manual focus.

20. A non-transitory computer-readable medium for causing a computer to execute a control method for an image capturing apparatus, the control method for the image capturing apparatus comprising:
allowing a focus mode to be set as autofocus to automatically focus on a subject or as manual focus to manually focus on a subject; and
controlling a multi-use operation member capable of switching to be operated as a first operation member for manual focus operation or operated as a second operation member for operation other than the manual focus operation, to be operated as the first operation member when a predetermined lens unit is mounted.
